(19) United States
(12) Patent Application Publication
(10) Pub. No.: US 2022/0300923 A1
(43) Pub. Date: Sep. 22, 2022

(54) SYSTEMS AND METHODS FOR SECONDARY MERCHANT CARD DELIVERY

(71) Applicant: Jessica S. Bobo, North Las Vegas, NV (US)

(72) Inventor: Jessica S. Bobo, North Las Vegas, NV (US)

(21) Appl. No.: 17/205,310

(22) Filed: Mar. 18, 2021

(51) Int. Cl. G06Q 20/10; G06Q 20/02; G06Q 20/38; G06Q 20/40; G06Q 40/02; G06Q 20/34; H04L 29/06; H04L 9/08

(52) U.S. Cl. CPC G06Q 20/1085; G06Q 20/02; G06Q 20/385; G06Q 20/4012; G06Q 40/02; G06Q 20/405; G06Q 20/4037; G06Q 20/3829; G06Q 20/3558; G06Q 20/3552; H04L 63/0428; H04L 9/0861; G06Q 2220/00

(57) ABSTRACT

A computing system for secondary merchant card delivery is provided. The computing system may include a processor coupled to a memory to execute secondary merchant card delivery using a secondary merchant card delivery agent of a mobile unit and a merchant card system of an ATM machine in communication with a networked server node. The processor may be operable to receive a user request using the merchant card agent and to send the user request to a server having a merchant card module. In addition, the processor may be operable to initiate a first security protocol and to generate, in response to verified security approval, a merchant card profile. Further, the processor may be operable to send the merchant card profile to the ATM merchant card system, whereby the processor is operable to generate a signal for initiation of generation of the secondary merchant card and dispense the same to the user.

### BACKGROUND

Most financial institutions issue to their customers merchant cards that enable the cardholder to pay for merchandise and services based upon an agreement between the institution and the customer. The card issuer ordinarily creates an account and grants the customer a line of credit to use, wherein the issuer charges interest and fees upon the balance and use, thereof. In general, it takes approximately 2-3 weeks to receive a merchant card from a financial institution after credit approval.

However, in the case of emergency loss, these types of financial instruments are not always easily accessible. In particular, if a customer were to lose the credit card due to an accidental loss or theft, it would take the bank approximately two weeks to generate and reissue the card. Particularly, it can take from 3-5 business days to process the administrative details to generate the card and another 7-10 business days to be sent through the postal system.

For some, writing a check may be a good alternative. However, the ability to use a check may not provide a good solution for several reasons. First, the customer may not have the cash liquid in their checking account; wherein, the customer had planned to use the line of credit extended to them by their merchant agreement. Secondly, in this digital era, few institutions still accept checks. In some instances where checks are accepted, the processing of the same tends to be a hassle, particularly when procedures are set in place to account for instances of check fraud.

It is within this context that the embodiments arise.

### SUMMARY

Embodiments of a networked computer system for secondary merchant card delivery are provided. It should be appreciated that the present embodiment can be implemented in numerous ways, such as a process, an apparatus, a system, a device, or a method. Several inventive embodiments are described below.

In some embodiments, a computing system for secondary merchant card delivery is provided. The computing system may include a processor coupled to a memory to execute secondary merchant card delivery scheme using a merchant card agent of a mobile unit and a merchant card system of an ATM machine in communication with a networked server node. In particular, the processor may be operable to receive a user request using the merchant card agent and to send the user request to a server having a merchant card agent. For example, the user may request a secondary merchant card using a mobile phone having the merchant card agent, wherein the merchant card agent communicates with the financial institution's server, which includes a merchant card module. Using a security hand-shaking process, the server's merchant card module may communicate with the ATM's merchant card system, wherein when the security process is cleared, the merchant card system can generate and dispense a secondary card to the user. More particularly, the processor of the server may be operable to initiate a first security protocol and to generate, in response to a verified security approval, a merchant card profile, including the user's name, an expiration date, a predetermined secondary card number and a pin code. Further, the server processor may be operable to send the merchant card profile to the ATM merchant card system, whereby the ATM processor is operable to generate signals to a merchant card generator for initiation of the generation and dispensing of the secondary merchant card. For example, the ATM processor may be operable to initiate a second security protocol to verify the authenticity of the user and user request. After verification of the user, the processor may be operable to parse the merchant card profile to retrieve to retrieve the user name, the expiration date, the predetermined secondary card number and the pin code. Additionally, the processor may be operable to actuate the merchant card generator to emboss, print, and program a blank card with the merchant data corresponding to the merchant card profile. Further, the processor may be operable to actuate a card-dispensing unit to retrieve the secondary merchant card and open a carriage unit to open for the dispensing of the secondary merchant card.

In some embodiments, a system and method for secondary merchant card delivery is provided. As an initialization process, the method may include receiving a user request using a merchant card agent. In response, the method may further include sending the user request to a server having a merchant card agent. A first security protocol may be initiated by the server in another step. For example, the server may request a passcode or an answer to a security question. In some embodiments, the server may initiate a secondary authentication request. In response to verified security approval, the server may generate a merchant card profile. For example, the server may retrieve a predetermined secondary card number and pin code and add these to a merchant card profile. Further, the server may parse a user name from an associated user profile and retrieve an expiration date associated with a merchant card policy. The server may also retrieve an account balance and predetermined limits of withdrawal associated with the user account. Ultimately, all associated data can be stored in the merchant card profile. The method may further include sending the merchant card profile to the ATM merchant card system. In some embodiments, the method may include initiating a second security protocol using the ATM merchant card system. Upon verification of security approval, the method may include generating a secondary merchant card. For example, an operation module of the merchant card system may instruct a merchant card generation unit to retrieve a blank card from a merchant card register bin. The merchant card generation unit may be operable to program a chip embedded on the blank card using a programming unit. Further, the merchant card generation unit may be operable to emboss the blank card using a printing unit. In addition, the merchant card generation unit may send the programmed card back to the merchant card register bin, along with a signal to a card-dispensing unit to enable the dispensing of the secondary merchant card to the user.

In some embodiments, a tangible, non-transitory, computer-readable media having instructions whereupon which, when executed by a processor, cause the processor to perform the secondary merchant card delivery method described herein. The method may include receiving a user request using a merchant card agent. In response, the method may further include sending the user request to a server having a merchant card agent. A first security protocol may be initiated by the server in another step. For example, the server may request a passcode or an answer to a security question. In some embodiments, the method may initiating a secondary authentication request. In response to verified security approval, the method may include generating a merchant card profile. For example, the server may retrieve a predetermined secondary card number and pin code and add these to a merchant card profile. Further, the server may parse a user name from an associated user profile and retrieve an expiration date associated with a merchant card policy. The server may also retrieve an account balance and predetermined limits of withdrawal associated with the user account. Ultimately, all associated data can be stored in the merchant card profile. The method may further include sending the merchant card profile to the ATM merchant card system. In some embodiments, the method may include initiating a second security protocol using the ATM merchant card system. Upon verification of security approval, the method may include generating and dispensing a secondary merchant card. For example, an operation module of the merchant card system may instruct a merchant card generation unit to retrieve a blank card from a merchant card register bin. The merchant card generation unit may be operable to program a chip embedded on the blank card using a programming unit and to emboss the blank card using a printing unit. Further, the merchant card generation unit may send the programmed card back to the merchant card register bin, along with a signal to a card-dispensing unit to enable the dispensing of the secondary merchant card to the user.

Other aspects and advantages of the embodiments will become apparent from the following detailed description taken in conjunction with the accompanying drawings which illustrate, by way of example, the principles of the described embodiments.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one so skilled in the art without departing from the spirit and scope of the described embodiments.

FIG. 1 is a system diagram of networked secondary merchant card delivery system having multiple ATM nodes coupled to a server, in accordance with some embodiments.

FIG. 2 is a block diagram showing the contents of a merchant card system of FIG. 1 in some embodiments.

FIG. 3 is a flow diagram of a method of secondary merchant card delivery in accordance with some embodiments.

FIG. 4 is an illustration showing an exemplary computing device, which may implement the embodiments described herein.

### DETAILED DESCRIPTION

The following embodiments describe a networked computer system for secondary merchant card delivery. It can be appreciated by one skilled in the art, that the embodiments may be practiced without some or all of these specific details. In other instances, well known process operations have not been described in detail in order not to unnecessarily obscure the embodiments.

The networked computer system for secondary merchant card delivery described herein may include a processor coupled to a memory to execute secondary merchant card delivery scheme using a merchant card agent of a mobile unit and a merchant card system of an ATM machine in communication with a networked server node. In particular, the processor may be operable to receive a user request using the merchant card agent and to send the user request to a server having a merchant card agent. For example, the user may request a secondary merchant card using a mobile phone having the merchant card agent, wherein the merchant card agent communicates with the financial institution's server, which includes a merchant card module. Using a security hand-shaking process, the server's merchant card module may communicate with the ATM's merchant card system. In particular, when the security process is cleared, the merchant card system can generate and dispense a secondary card to the user. More particularly, the processor of the server may be operable to initiate a first security protocol and to generate, in response to a verified security approval, a merchant card profile, including the user's name, an expiration date, a predetermined secondary card number, and a pin code. Further, the server processor may be operable to send the merchant card profile to the ATM merchant card system, whereby the ATM processor is operable to generate signals to a merchant card generator for initiation of the generation and dispensing of the secondary merchant card. For example, the ATM processor may be operable to initiate a second security protocol to verify the authenticity of the user and user request. After verification of the user, the processor may be operable to parse the merchant card profile to retrieve the user name, the expiration date, the predetermined secondary card number and the pin code. Additionally, the processor may be operable to actuate the merchant card generator to emboss, print, and program a blank card with the merchant data corresponding to the merchant card profile. Further, the processor may be operable to actuate a card-dispensing unit to retrieve the secondary merchant card and to open a carriage unit that enables the dispensing of the secondary merchant card to the user.

In some embodiments, the server may include a merchant card agent in lieu of the merchant card module. Further, the client node may include other computing devices other than a smart mobile phone.

Advantageously, a customer of any financial institution can securely access a secondary merchant card swiftly. Moreover, most financial institution can implement the networked system disclosed herein in a cost effective manner.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed descriptions, which follow, are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “generating,” “sending,” “comparing,” “updating,” “initiating,” “retrieving,” “prompting”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Reference in the description to “one embodiment” or “an embodiment” means that a particular feature, structure, or characteristic described in connection with the embodiment is included in at least one embodiment of the invention. The phrase “in one embodiment” located in various places in this description does not necessarily refer to the same embodiment. Like reference numbers signify like elements throughout the description of the figures.

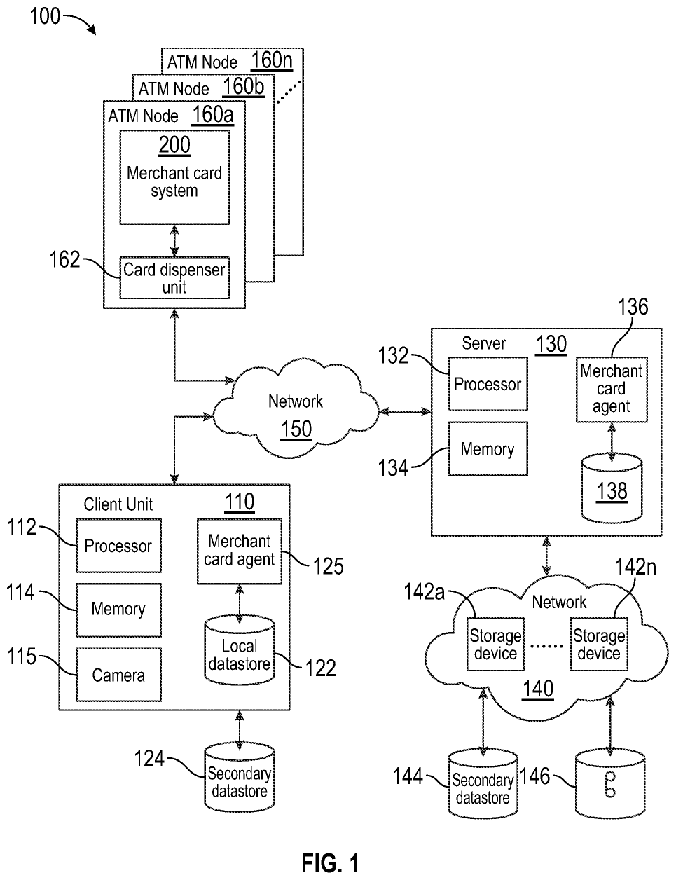

Referring to FIG. 1, a system diagram of networked computer system for secondary merchant card delivery having one or more client units 110 coupled to at least one ATM node (160a-160n), which couples remotely to a server 130 to provide a merchant card profile, in accordance with some embodiments is shown. The system includes at least one client unit 110, a network 150, at least one ATM node 160a-n, a server 130, and a plurality of secondary storage devices 142a-n, 144, and 146. In some embodiments, each ATM node 160a-n includes a card dispenser unit 162 for enabling customer access to the new secondary merchant card. Each client unit 110, having local data store 122, camera 115, and secondary datastore 124, may be coupled by a network 150 to the financial institution's server 130, having its own merchant card module 136, local datastore 138, and one or more remote cloud storage devices 142a-n. Each client unit 110 may include a merchant card agent 125, memory 114, processor 112, and local data store 122. In some embodiments, the client unit 110 may also include a secondary datastore 124. Examples of the client units 110 may include, but are not limited to, personal computers, laptops, PDAs, mobile phones, computing tablets, network appliances, and the like. In some embodiments, the merchant card agent 125 may serve as a device that communicates with the merchant card server 130 to request the method of merchant card generation and delivery described more in detail below. In other embodiments, the merchant card module 136 within the server 130 may communicate with each client node 110 and serve as the sole agent that performs the method of merchant card generation and delivery described herein. Each client node 110, server 130, and the storage devices 142a-n may reside on the same LAN, or on different LANs that may be coupled together through the Internet, but separated by firewalls, routers, and/or other network devices. In one embodiment, one or more client nodes 110 may couple to network 150 through a mobile communication network. In another embodiment, each client node 110, server 130, and the storage devices 142a-n may reside on different networks. In some embodiments, the server 130 may reside in a cloud network. Although not shown, in various embodiments, the client node 110 may be notebook computers, desktop computers, microprocessor-based or programmable consumer electronics, network appliances, computing tablets, mobile telephones, smart telephones, pagers, radio frequency (RF) devices, infrared (IR) devices, Personal Digital Assistants (PDAs), set-top boxes, cameras, integrated devices combining at least two of the preceding devices, and the like.

In some embodiments, server 130 may comprise a processor 132, memory 134, local datastore 138, and merchant card agent 136. In particular, the merchant card agent 136 may comprise processing software instructions and/or hardware logic required for merchant card generation and delivery according to the embodiments described herein. In some embodiments, the server 130 may include a merchant card agent similar to the agent 125 of the client unit 110. Server 130 may provide remote cloud storage capabilities for merchant card records storage, user profile data, accounting information, through the storage devices 142a-n coupled by network 140. Further, these may couple to one or more tape-out devices 146 or any other secondary datastore 144. The merchant card server 130 may also comprise a local data storage unit 138, which can be one or more centralized data repositories having user profile and merchant card request profile information within a remote storage devices 142a-n. The local data store may represent a single or multiple data structures (databases, repositories, files, etc.) residing on one or more mass storage devices, such as magnetic or optical storage based disks, tapes or hard drives. This local data store may be an internal component of the merchant card server 130. The local data store also may couple externally to merchant card server 130, or remotely through a network. The merchant card server 130 can communicate with the remote storage devices 142a-n over a public or private network. Although not shown, in various embodiments, server 130 may be a notebook computer, desktop computer, microprocessor-based or programmable consumer electronics, network appliance, mobile telephone, smart telephone, radio frequency (RF) device, infrared (IR) device, Personal Digital Assistant (PDA), set-top box, an integrated device combining at least two of the preceding devices, and the like.

In some embodiments, the system 100 may include remote data storage units and tape-out devices 146 coupled by a network to one or more client nodes 110. As such, a database of merchant card profiles and/or policies may be stored within the local data store (122), remote disks 142a-n, secondary data store (124, 144), or tape-outs devices 146. The database may include specific processes or policies associated with merchant card delivery. In some embodiments, client node 110 may retrieve previous results relating to a prior merchant card delivery initially from a remote datastore to a local data store 122. In other embodiments, a database of merchant card policies may be stored locally on the client node 110. In the alternative, these merchant policies may be stored on the merchant card server 130.

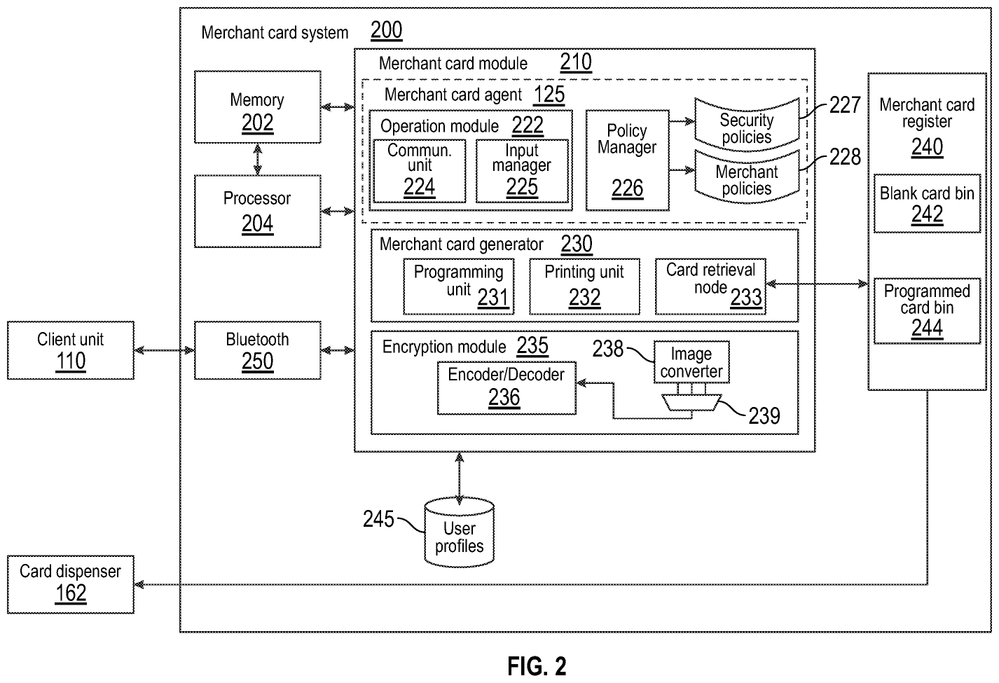

In operation, computing system 100, including processor 112 coupled to memory 114, may execute the secondary merchant card delivery scheme using the merchant card agent 125 of a client node 110 and the merchant card system 200 of an ATM machine/node 160 in communication with the networked server node 130. In particular, processor 112 may be operable to receive a user request using the merchant card agent and to send the user request to a server 130 having a merchant card agent 125. More particularly as an example, the user may initiate a request for a secondary merchant card using a mobile phone as the client unit 110 having the merchant card agent 125, wherein the merchant card agent 125 communicates with the financial institution's server 130, which includes a merchant card module 136. Merchant card agent 125 may couple to the memory 114 and processor 112 to execute a merchant card generation and delivery scheme; wherein, the merchant card agent 125 is responsive to a user request for a secondary merchant card. For example, when requested by the user, the merchant card agent 125, in coordination with processor 112, and memory 114, can send an instruction to server 130 using network 150. Using a security hand-shaking process, the server's merchant card module 136 may communicate with the ATM's merchant card system 200, wherein when the security process is cleared, the merchant card system 200 can generate and dispense a secondary card to the user. More particularly, the processor 132 of server 130 may be operable to initiate a first security protocol and to generate, in response to a verified security approval, a merchant card profile, including the user's name, an expiration date, a predetermined secondary card number and a pin code. In particular, the processor 132 may be operable to retrieve a user profile from a local (138) or remote (144) datastore. The processor 132 may also be operable to actuate the merchant card module 136 to generate the merchant card profile, using a policy manager 226 having security and merchant policies (to be described more in detail with reference to FIG. 2). Further, processor 132 may be operable to send the merchant card profile to the ATM merchant card system 200, whereby the ATM processor (204) is operable to generate signals to a merchant card generator (230) for initiation of the generation and dispensing of the secondary merchant card.

In some embodiments, in response to the user's request, the merchant card system 200 may couple to receive an image file from the client unit 110. The digital image file can be retrieved from the local datastore 122. The merchant card agent 136 can convert the digital image file and generate a key for the symmetric encryption of the merchant card profile (to be discussed in detail with respect to FIG. 2). When the user arrives at one of the ATM nodes (160a-n), the merchant card system 200 solicits from the user the digital image again, which can be used to generate a key for decrypting the merchant card profile.

Advantageously, the client node 110 can be a portable handheld device that can be used to generate a secondary merchant card at an ATM machine securely and swiftly.

It is appreciated that the components of exemplary operating environment 100 are exemplary and more or fewer components may be present in various configurations. It is appreciated that operating environment may be part of a distributed computing environment, a cloud computing environment, a client server environment, and the like. In other words, as would be apparent to one of ordinary skill in the art after reading this description, the various features and functionality described herein may be implemented in the merchant card system using any arrangement components necessary to perform the secondary merchant card generation and delivery; and can be implemented in one or more separate or shared modules in various combinations and permutations.

Referring the FIG. 2, a block diagram showing the contents of the merchant card system 200 of FIG. 1 in some embodiments is shown. An exemplary embodiment of the merchant card system 200 may include a memory 202, a processor 204, a merchant card module 210, merchant card register 240 and a local datastore 245. Further, merchant card system 200 may include a Bluetooth unit 250 for enabling communication with a client unit 110. Merchant card module 210 may include a merchant card agent 125, a merchant card generator 230, and an encryption module 235. The merchant card agent 125 may include an operation module 222, having a communication unit 224 and input manager 225 [both for communicating with the client unit 110 and the ATM node (160a-d)], and a policy manager 226, having security policies 227 and merchant policies 228 which include rules for defining the security and merchant policies during each security authentication session. The merchant card generator 230 may include a programming unit 231, a printing unit 232, and a card retrieval node 233, wherein when card retrieval node 233 retrieves a secondary merchant card from the merchant card register 240, the programming unit 231 programs the merchant card and the printing unit 232 prints/embosses data on the card.

In some embodiments, the merchant card register 240 may include a blank card bin 242 and a programmed card bin 244; wherein the blank card bin 242 has the capacity to hold blank programmable cards. In some embodiments, these programmable cards can possess a magnetic stripe that can be programmed with the merchant card profile information. In particular, processor 204 can be operable to parse the user's name, an expiration date, a predetermined secondary card number and a pin code from the merchant card profile. The parsed information can be used by the merchant card generator 230 for programming the card with information specific to the client request. In another embodiment, these programmable cards can possess a chip embedded in the card, which may be programmed with information from the merchant card profile. After, the cards have been programmed by the merchant card generator 230, the programmed card bin 244 can be used to store the programmed cards. The merchant card register 240 in cooperation with processor 204 may also be operable to communicate with the card dispenser unit 162 for delivery of a secondary merchant card, once the card is programmed.

In some embodiments, the encryption module 235 may include an encoder/decoder 236, an image converter 238 and multiplexer 239. The encryption module 235 can be used to provide data encryption for the merchant card profile that is to be sent to the ATM node (160a-n). In particular, when the user submits a digital image file, along with the user's request for a secondary merchant card, the image converter 238 can generate a three dimensional array representing the image. The multiplexer 239 can multiplex the output of the image converter 238 to provide a key for the encoder/decoder 236 to generate an encrypted merchant card profile to be sent to the ATM nod (160a-n).

In some embodiments, the server 130 may include a merchant card agent 125 likened to the client unit 110 of FIG. 1. In other embodiments, the server 130 may include a merchant card module that is liked unto the merchant card module 210, wherein the secondary card can be generated at a financial institution's location.

In operation, a user at the client unit 110 may request a secondary merchant card by communicating directly with server 130 in accordance with some embodiments. In particular, the processor 112 can be operable to send a user request directly to the server 130 before the user goes to the ATM node 160. In some embodiments, the processor 112 is operable to retrieve a digital image from the client unit 110 to be used to derive a key for the encryption of a merchant card profile. In response to an authenticated security protocol, the server 130 can generate the merchant card profile relating to the user request, which will be sent to one of the available ATM nodes (160a-n) selected by the user. At a later point in time, the user can go to an ATM 160a-n and place a final request for the secondary merchant card. In some embodiments, when the user arrives and accesses ATM node 160, the ATM processor 204 may be operable to initiate the first security protocol and a secondary security protocol to verify the authenticity of the user and the user's request. The ATM processor 204 may also be operable to retrieve a second copy of the digital image sent during the user request to generate a key for decryption of the merchant card profile. In some embodiments, the user can go directly to the ATM node 160 to place the initial user request and be led through a first and second security protocol. In the alternative, the user can place a request at a differing location and then later pick up the card at an ATM of its own choosing.

Alternatively, it is the processor 204 of the ATM node 160 that can be operable to send the primary user request to the server 130 as indicated previously with respect to FIG. 1 in accordance with some embodiments. In particular, the user at client unit 110 may request a secondary merchant card by communicating directly with ATM node 160 using the Bluetooth functionalities of the computing unit 110 in cooperation with the Bluetooth unit 250. The ATM node 160 can forward the user request on to the server 130. Particularly, the processor 204 may be operable to actuate the operations module 222 using the communication unit 224 to prompt user input, and the input manager 225 to receive the user request, which will be sent to the server 130 for authentication and generation of a merchant card profile.

Upon authentication of the primary security protocol, server 130 can generate the merchant card profile relating to the user's request. As noted previously in some embodiments, server 130 can include a merchant card module similar to merchant card module 210 of FIG. 2. In other embodiments, server 130 may include a merchant card agent similar to the merchant card agent 125 of FIG. 1. Particularly, processor 132 may retrieve data related to financial records, the user's profile, and the like from a local (138) or remote (142a-n, 144, 146) datastore.

Using the encryption/decryption module 235, the merchant card module 210 of the server 130 may encrypt the merchant card profile before sending this profile to the ATM node 160. In particular, encryption module 235 may include an encoder/decoder unit 236 that couples to receive a digital image of the user from the user's mobile device (client unit 110). In some embodiments, the digital image can be captured using the camera 115 of the client unit 110. In other embodiments, the digital image may be a previously captured image file stored within database 122 of the client unit 110. As noted previously, the encryption module 235 may include an encoder/decoder unit 236 that couples to receive a key from multiplexer 239. Particularly, the image converter 238 may couple to receive the digital image file uploaded by the user to generate a 3-dimensional array that may be multiplexed together using the three-input multiplexer 239 to generate the key. More particularly, the image converter 238 may convert the jpeg image into a three-dimensional array of numbers (i.e. R, G, B). In some embodiments, the encoder/decoder unit 236 may convert the jpeg image into a five-dimensional array (i.e. x, y, R, G, B). The numbers of the array can be multiplexed together to generate the key for encryption of the merchant card profile. Accordingly, the encoder/decoder 236 may use the key to encrypt the merchant card profile and the encrypted merchant card profile can be sent to at least one of the ATM nodes (160a-n). In some embodiments where asymmetric encryption is used, a public key may be sent along with the encrypted merchant card profile to the ATM nodes (160a-n). Regarding the ATM node selection, the specific ATM node (160a-n) may be chosen by the user as relayed in the user's initial request. In other embodiments, the ATM node (160a-n) may be selected and predetermined by the server 130.

Upon receipt of the merchant card profile at one of the ATM nodes (160a-n), the merchant card module 210 can be operable to initiate a second security protocol. In particular, the operation module 222 in cooperation with the policy manager 226 can communicate to the user to initiate a second security authentication process in accordance with the security policies 229. In some embodiments, the security process can be defined by the security policies 229, wherein the merchant card system 200 requests a digital certificate or pin from the user through its communication with the client unit 110 through the Bluetooth unit 250. Another security process may include having the merchant card system 200 to pose a security question to the client unit 110 using the communication unit 224 and to seek an answer using the input manager 225. In some embodiments the security protocol may include having the operation module 222 to retrieve a user profile from either a local or remote datastore for authentication destination information. In particular, the processor 204 in cooperation with the operation module 222 can be operable to send a passcode to the authentication destination. For example, the authentication destination may be a phone number related to the user, wherein a text message code can be sent to the user's phone. In the alternative, operation module 222 may initiate a call the user's phone and play a recording with the code inserted within the message. In response, the user at the client unit 110 would be able to provide the passcode to the merchant card system 200 in order to verify that the second security process has been authenticated.

After verification of the user, processor 204 may be operable to parse the merchant card profile to retrieve the user name, the expiration date, the predetermined secondary card number and the pin code. Additionally, the processor 204 may be operable to actuate the merchant card generator 230 to emboss, print, and program a blank card with the merchant data corresponding to the merchant card profile. Further, the processor 204 may be operable to actuate a card-dispensing unit 162 to retrieve the secondary merchant card and open a carriage bin within the unit 162 to open for the dispensing of the secondary merchant card. In particular, the merchant card system 200 can select a blank card from the merchant card register 240 using the card retrieval node 236 and send the card to the merchant card generator 230 for printing and programming. In particular, the processor 204 in collaboration with the merchant card generator 230 may access the blank card bin 242 for retrieval of a blank programmable merchant card. Further, the merchant card generator 230 can actuate the programming unit 232 to program the blank card with financial data retrieved from the merchant card profile. In some embodiments, the merchant card generator 230 can actuate the programming unit 232 to program the blank card with processes as defined by the merchant policies 228. Additionally, the merchant card generator 230 can actuate the printing unit 234 to print the merchant card number on the blank card, whether by laser printing or using a stamping mechanism to emboss the card with the merchant number.

As to decryption of the merchant card profile, the merchant card system 200 can decode the profile using the encryption/decryption module 235 and a copy of the digital image provided again by the user at the ATM node (160a) via the software installed (merchant card agent 125) on the user's mobile unit (client unit 110), wherein the digital image is a file stored in database 122. That is, the same digital image that was used as a key to encrypt the data when the user first requests a secondary merchant card can be used as the key to decrypt the merchant card profile at the ATM node (160a-d), when the user comes to the ATM node (160a-n) to pick up the secondary merchant card. In particular, encoder/decoder unit 236 may decrypt the profile by shifting the data of the merchant card profile in reverse using an decryption code derived by the key generated by the digital image.

In some embodiments, the blank cards stored in the blank card bin 242 of the Merchant Card register 240 may include the logo of the institution, an Europay, Mastercard, Visa (EMV) chip, a hologram, a card network logo, a contactless chip, a magnetic strip, and the like. When the card retrieval node 236 retrieves the blank card for printing and programming, the printing unit 234 may print the card number, expiration date, and the user name on the front of the card. Further, the printing unit 234 may print the card security code on the backside of the card. In addition, the programming unit 232 may program the EMV chip with the user pin number and other merchant data retrieved from the merchant card profile. Further, the programming unit 232 may program the EMV chip with processes as defined by the merchant policies 228. In some embodiments, the merchant card module 210 can use the policy manager 226 in communication with merchant policies 228 to set a temporary credit limit on the secondary card that is issued.

Once the card is programmed and the printing is completed, the merchant card generator 230 can actuate the card retrieval node 236 to send the card to the programmed card bin 244. At this point, the merchant card register 240 in cooperation with the processor 204 can send signals to the card dispenser unit 162 to release the programmed card for user access.

As used herein, the term agent and module might describe a given unit of functionality that can be performed in accordance with one or more embodiments of the present invention. As used herein, an agent and/or a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

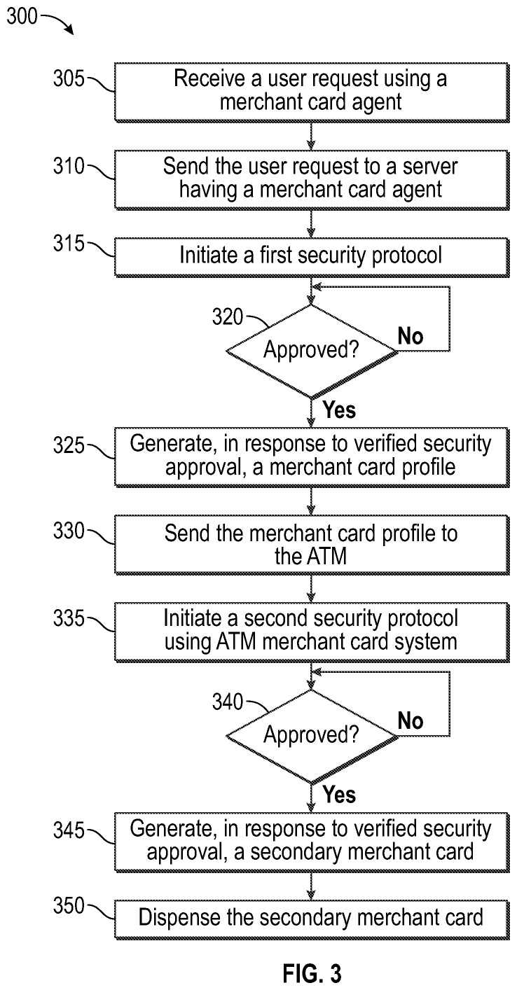

Referring to FIG. 3, a flow diagram of a method of secondary merchant card delivery in accordance with some embodiments is shown. The method may include receiving a user request using a merchant card agent in an action 305. In response, the method in an action 310 may further include sending the user request to a server having a merchant card agent. In some embodiments the digital image may be sent by the user with the user request to the server for the purposes of data encryption at action 310. A first security protocol may be initiated by the server 130, in an action 315. For example, the server may request a passcode or an answer to a security question. In some embodiments, the method may include initiating a secondary authentication request. In response to verified security approval through decision action 320, the method may include generating a merchant card profile in an action 325. For example, the server may retrieve a user profile having a predetermined secondary card number and pin code from either a local or remote datastore for the purpose of generating a merchant card profile. Further, the server may parse a user name from an associated user profile and retrieve an expiration date associated with a merchant card policy. The server may also retrieve an account balance and predetermined limits of withdrawal associated with the user account. Ultimately, all associated data can be stored in the merchant card profile. The method may further include sending the merchant card profile to the ATM merchant card system in an action 330. In some embodiments, the method in an action 335 may include initiating a second security protocol using the ATM merchant card system. In some embodiments, the user can transmit the digital image to be used as the key for decrypting the merchant card profile during the second security protocol in the action 335. Upon verification of security approval through decision action 340, the method may include generating and dispensing a secondary merchant card in an action 345. For example, an operation module of the merchant card system may instruct a merchant card generation unit to retrieve a blank card from a merchant card register bin. The merchant card generation unit may be operable to program a chip embedded on the blank card using a programming unit and to emboss the blank card using a printing unit. Further in an action 350, the merchant card generation unit may send the programmed card back to the merchant card register bin, along with a signal to a card-dispensing unit to enable the dispensing of the secondary merchant card to the user.

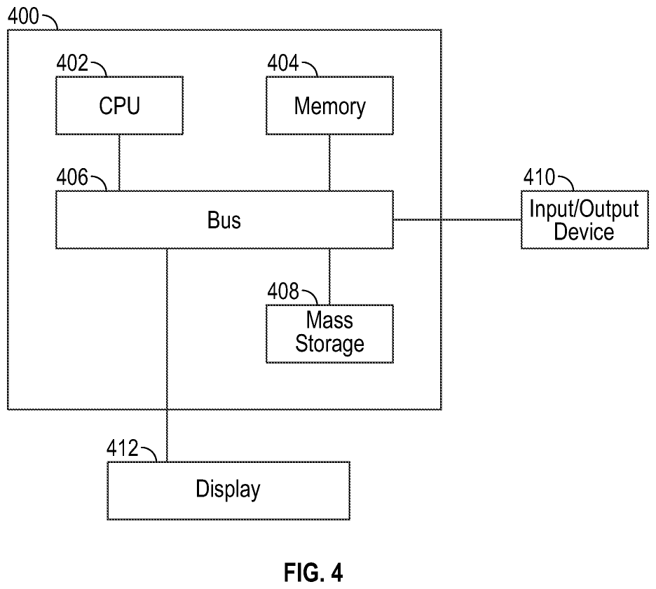

It should be appreciated that the methods described herein may be performed with a digital processing system, such as a conventional, general-purpose computer system. Special purpose computers, which are designed or programmed to perform only one function may be used in the alternative. FIG. 4 is an illustration showing an exemplary computing device, which may implement the embodiments described herein. The computing device of FIG. 4 may be used to perform embodiments of the functionality for performing merchant card generation and delivery in accordance with some embodiments. The computing device includes a central processing unit (CPU) 402, which is coupled through a bus 406 to a memory 404, and mass storage device 408. Mass storage device 408 represents a persistent data storage device such as a floppy disc drive or a fixed disc drive, which may be local or remote in some embodiments. The mass storage device 408 could implement a backup storage, in some embodiments. Memory 404 may include read only memory, random access memory, etc. Applications resident on the computing device may be stored on or accessed through a computer readable medium such as memory 404 or mass storage device 408 in some embodiments. Applications may also be in the form of modulated electronic signals modulated accessed through a network modem or other network interface of the computing device. It should be appreciated that CPU 402 may be embodied in a general-purpose processor, a special purpose processor, or a specially programmed logic device in some embodiments.

Display 412 is in communication with CPU 402, memory 404, and mass storage device 408, through bus 406. Display 412 is configured to display any visualization tools or reports associated with the system described herein. Input/output device 410 is coupled to bus 406 in order to communicate information in command selections to CPU 402. It should be appreciated that data to and from external devices may be communicated through the input/output device 410. CPU 402 can be defined to execute the functionality described herein to enable the functionality described with reference to FIGS. 1-3. The code embodying this functionality may be stored within memory 404 or mass storage device 408 for execution by a processor such as CPU 402 in some embodiments. The operating system on the computing device may be iOS™, MS-WINDOWS™, OS/2™, UNIX™, LINUX™, or other known operating systems. It should be appreciated that the embodiments described herein may be integrated with virtualized computing system also.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “I” symbol includes any and all combinations of one or more of the associated listed items. As used herein, the singular forms “a”, “an” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved. With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

A module, an application, a layer, an agent or other method-operable entity could be implemented as hardware, firmware, or a processor executing software, or combinations thereof. It should be appreciated that, where a software-based embodiment is disclosed herein, the software can be embodied in a physical machine such as a controller. For example, a controller could include a first module and a second module. A controller could be configured to perform various actions, e.g., of a method, an application, a layer or an agent.

The embodiments can also be embodied as computer readable code on a non-transitory computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, flash memory devices, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

In various embodiments, one or more portions of the methods and mechanisms described herein may form part of a cloud-computing environment. In such embodiments, resources may be provided over the Internet as services according to one or more various models. Such models may include Infrastructure as a Service (IaaS), Platform as a Service (PaaS), and Software as a Service (SaaS). In IaaS, computer infrastructure is delivered as a service. In such a case, the computing equipment is generally owned and operated by the service provider. In the PaaS model, software tools and underlying equipment used by developers to develop software solutions may be provided as a service and hosted by the service provider. SaaS typically includes a service provider licensing software as a service on demand. The service provider may host the software, or may deploy the software to a customer for a given period of time. Numerous combinations of the above models are possible and are contemplated.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method of secondary merchant card delivery comprising:
receiving a user request using a merchant card agent;
sending the user request to a server having a merchant card agent;
initiating a first security protocol;
generating, in response to verified security approval, a merchant card profile;
encrypting the merchant card profile;
sending the encrypted merchant card profile to the ATM merchant card system;
initiating a second security protocol using ATM merchant card system;
decrypting the encrypted merchant card profile;
generating, in response to verified security approval, a secondary merchant card based upon the decrypted merchant card profile; and
dispensing the secondary merchant card.

2. The method of claim 1, wherein receiving user request comprises:
prompting user for information associated with a request for a secondary merchant card;
prompting user for a digital image file;
receiving a user actuated signal; and
updating user profile.

3. The method of claim 1, wherein initiation of the first security protocol comprises:
requesting user input of passcode;
receiving user passcode;
comparing user passcode with user profile;
enabling, in response to verified passcode, access to merchant card option; and
updating user profile.

4. The method of claim 1, wherein initiation of the first security protocol comprises:
generating secondary passcode;
retrieving user profile;
parsing user profile for secondary authentication reference;
sending secondary passcode to secondary authentication reference;
prompting user for secondary passcode;
receiving a passcode from user;
comparing the passcode with the secondary passcode;
enabling, in response to a match of the secondary passcode, access to merchant card option; and
updating user profile.

5. The method of claim 1, wherein initiation of the first security protocol comprises:
prompting user with a security question;
receiving user input as an associated answer to the security question;
comparing user input with user profile;
enabling, in response to a matched answer, access to merchant card option; and
updating user profile.

6. The method of claim 1, wherein generating the merchant card profile comprises:
retrieving a predetermined secondary card number and pin code;
initializing the merchant card profile with the predetermined secondary card number and pin code;
parsing a user name from an associated user profile;
adding the user name to the merchant card profile;
retrieving an expiration date associated with a merchant card policy;
adding the expiration date to the merchant card profile;
retrieving account balance and predetermined limits of withdrawal associated with the user account;
adding the account balance and predetermined limits of withdrawal to the merchant card profile; and
updating user profile.

7. The method of claim 1, wherein encrypting the merchant card profile comprises:
converting the digital image file into a three-dimensional array;
multiplexing the array to generate an encryption key; and
transposing the merchant card profile using the encryption key and a predetermined encryption algorithm.

8. The method of claim 1, wherein initiating the second security protocol comprises:
requesting user input of passcode;
receiving user passcode;
comparing user passcode with user profile;
enabling, in response to verified passcode, access to merchant card option; and
updating user profile.

9. The method of claim 1, wherein initiating the second security protocol comprises:
generating secondary passcode;
retrieving user profile;
parsing user profile for secondary authentication reference;
sending secondary passcode to secondary authentication reference;
prompting user for secondary passcode;
receiving a code from user;
comparing the code with the secondary passcode;
enabling, in response to a match of the secondary passcode, access to merchant card option; and
updating user profile.

10. The method of claim 1, wherein decrypting the encrypted merchant card profile comprises:
prompting user the copy of the digital image;
converting the copy of the digital image file into a three-dimensional array;
multiplexing the array to generate an decryption key; and
transposing the merchant card profile using the decryption key and a predetermined decryption algorithm.

11. The method of claim 1, wherein generating the secondary merchant card comprises:
parsing the merchant card profile to retrieve the user name, the expiration date, the predetermined secondary card number and the pin code;
retrieving a blank card from a merchant card bin;
embossing the user name, expiration date, and predetermined secondary card number on the blank card;
printing the pin code on the back of the blank card; and
programming the micro-chip on the blank card with balance and predetermined limits of withdrawal based upon a merchant policy.

12. The method of claim 1, wherein the dispensing the secondary merchant card comprises:
transferring the card from the programming unit of the merchant card system to a card dispenser bin; and
actuating door to open to the card dispenser bin for user access.

13. A secondary merchant card delivery system comprising:
a memory; and
a processor coupled to the memory, the processor operable to:
receive a user request using a merchant card agent;
send the user request to server having a merchant card module;
initiate a first security protocol;
generate, in response to verified security approval, a merchant card profile;
send the merchant card profile to the ATM merchant card system;
initiate a second security protocol using the ATM merchant card system;
generate, in response to verified security approval, a secondary merchant card; and
dispense the secondary merchant card.

14. The secondary merchant card delivery system of claim 13, wherein the processor, for the receiving user request operable to:
prompt user for information associated with a request for a secondary merchant card;
receive a user actuated signal; and
update user profile.

15. The secondary merchant card delivery system of claim 13, wherein the processor, for the initiation of the first security protocol operable to:
prompt user with a security question;
receive user input as an associated answer to the security question;
compare user input with user profile;
enable, in response to a matched answer, access to merchant card option; and
update user profile.

16. The secondary merchant card delivery system of claim 13, wherein the processor, for the generating the merchant card profile operable to:
retrieve a predetermined secondary card number, a pin code, and a digital image file;
initialize the merchant card profile with the predetermined secondary card number and pin code;
parse a user name from an associated user profile;
add the user name to the merchant card profile;
retrieve an expiration date associated with a merchant card policy;
add the expiration date to the merchant card profile;
retrieve account balance and predetermined limits of withdrawal associated with the user account;
add the account balance and predetermined limits of withdrawal to the merchant card profile; and
update user profile.

18. The secondary merchant card delivery system of claim 13, wherein the processor, for the generating the secondary merchant card operable to:
parse the merchant card profile to retrieve the user name, the expiration date, the predetermined secondary card number and the pin code;
retrieve a blank card from a merchant card bin;
emboss the user name, expiration date, and predetermined secondary card number on the blank card;
print the pin code on the back of the blank card; and
program the micro-chip on the blank card with balance and predetermined limits of withdrawal based upon a merchant policy.

19. A non-transitory computer-readable medium including code for performing a method, the method comprising:
receiving a user request using a merchant card agent;
sending the user request to a server having a merchant card module;
initiating a first security protocol;
generating, in response to verified security approval, a merchant card profile;
sending the merchant card profile to the ATM merchant card system;
initiating a second security protocol using the ATM merchant card system;
generating, in response to verified security approval, a secondary merchant card; and
dispensing the secondary merchant card.

19. The computer-readable medium of claim 18, the initiation of the first security protocol comprises:
generating secondary passcode;
retrieving user profile;
parsing user profile for secondary authentication reference;
sending secondary passcode to secondary authentication reference;
prompting user for secondary passcode;
receiving a passcode from user;
comparing the passcode with the secondary passcode;
enabling, in response to a match of the secondary passcode, access to merchant card option; and
updating user profile.

20. The computer-readable medium of claim 18, wherein generating the secondary merchant card comprises:
parsing the merchant card profile to retrieve the user name, the expiration date, the predetermined secondary card number and the pin code;
retrieving a blank card from a merchant card bin;
embossing the user name, expiration date, and predetermined secondary card number on the blank card;
printing the pin code on the back of the blank card; and
programming the micro-chip on the blank card with balance and predetermined limits of withdrawal based upon a merchant policy.
